(19) United States
(12) Patent Application Publication
(10) Pub. No.: US 2018/0188895 A1
(43) Pub. Date: Jul. 5, 2018

(54) DISPLAY DEVICE AND METHOD FOR FABRICATING A DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Xiaoqing PENG, Beijing (CN); Huishun CHEN, Beijing (CN); Li MA, Beijing (CN); Kaixuan WANG, Beijing (CN); Hongliang YUAN, Beijing (CN); Yong ZHANG, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/563,195

(22) PCT Filed: Feb. 17, 2017
(86) PCT No.: PCT/CN2017/073902

§ 371 Date: Sep. 29, 2017

(30) Foreign Application Priority Data
May 19, 2016 (CN) 201610334359.1

(51) Int. Cl. G06F 3/043

(52) U.S. Cl. CPC G06F 3/0433

(57) ABSTRACT

The present disclosure relates to a display device and a fabricating method for fabricating a display device. The display device includes a base layer, a display panel located on the base layer, a display panel cover located on the display panel, wherein the display device further includes a piezoelectric sensing layer provided between the display panel cover and the base layer.

### CROSS REFERENCE TO RELATED APPLICATIONS

This patent application is a National Stage Entry of PCT/CN2017/073902 filed on Feb. 17, 2017, which claims the benefit and priority of Chinese Patent Application No. 201610334359.1 filed on May 19, 2016, the disclosures of which are incorporated herein by reference in their entirety as part of the present application.

### BACKGROUND

The present disclosure relates to the field of display technologies, and more particularly, to a display device and a method for fabricating a display device.

A pressure sensing touch display device possesses functions of display, planar touch on a display panel and pressure sensing in the direction perpendicular to the panel. It generally includes components regarding display function, touch, and pressure sensing function. However, currently no suitable integrated solution has been formed in the field. With increasingly high requirements for display effect and cost in the market, there are high requirements for the overall design of pressure sensing touch display products, yield improvement, and cost reduction.

### BRIEF DESCRIPTION

The embodiments of the present disclosure provide a display device, display panel, backlight module, and a method for fabricating a display device.

The present disclosure provides a display device.

A first aspect of the present disclosure provides a display device including a base layer, a display panel located on the base layer, a display panel cover located on the display panel, wherein the display device further includes a piezoelectric sensing layer provided between the display panel cover and the base layer.

In one embodiment, the piezoelectric sensing layer includes a polymeric piezoelectric material.

Alternatively, the polymeric piezoelectric material includes polyvinylidene fluoride.

In one embodiment, the piezoelectric sensing layer is located between the display panel cover and the display panel.

In one embodiment, the piezoelectric sensing layer is located between the display panel and the base layer.

Alternatively, the display panel is a liquid crystal display panel, and the base layer includes a backlight module.

Alternatively, the display panel is an organic light emitting diode display panel, and the base layer includes a base substrate.

Alternatively, the organic light emitting diode display panel is an active matrix organic light emitting diode display panel.

The present disclosure also provides a display panel.

A second aspect of the present disclosure provides a display panel, wherein, a piezoelectric sensing layer is provided on the display side or the side opposite to the display side of the display panel.

The present disclosure also provides a backlight module.

A third aspect of the present disclosure provides a backlight module, wherein, a piezoelectric sensing layer is provided on the light exit side of the backlight module.

The present disclosure also provides a method of fabricating a display device.

A fourth aspect of the present disclosure provides a method of fabricating a display device, the method including providing a base layer, providing a display panel on the base layer, providing a display panel cover on the display panel, wherein, the method further includes providing a piezoelectric sensing layer between the display panel cover and the base layer.

In one embodiment, the piezoelectric sensing layer is located between the display panel cover and the display panel.

In one embodiment, the piezoelectric sensing layer is located between the display panel and the base layer.

Alternatively, providing the piezoelectric sensing layer includes forming a polyvinylidene fluoride film, carrying out a stretching treatment on the polyvinylidene fluoride film so that the polyvinylidene fluoride film has a selected length and a selected thickness, and providing a transparent conductive oxide layer on each of the upper and lower surfaces of the polyvinylidene fluoride film, respectively.

Alternatively, the selected length of the polyvinylidene fluoride film is about 3.5 to 5.5 times the length prior to the treatment and the selected thickness of the polyvinylidene fluoride film is in the range of from about 40 μm to 300 μm.

Alternatively, the formation of the polyvinylidene fluoride film is carried out at a temperature of from about 210° C. to 250° C.

The stretching treatment is carried out at a temperature of from about 60° C. to 85° C. in a polarized electric field of from about 40 to 60 MV/m.

Alternatively, the transparent conductive oxide layer includes ITO, and the method further includes providing a pressure-sensitive adhesive on at least one surface of the polyvinylidene fluoride film, and joining the polyvinylidene fluoride film with the display panel or the base layer via the pressure-sensitive adhesive.

### BRIEF DESCRIPTION OF THE DRAWINGS

In order to more clearly illustrate the technical solutions of the embodiments of the present disclosure, the drawings of the embodiments will be briefly described below. It should be understood that the drawings described below relate only to some embodiments of the present disclosure instead of limiting the present disclosure, in which:

FIG. 1 is a schematic view of the structure of a display device in the prior art;

FIG. 2A is a schematic view of the structure of a display device according to an embodiment of the present disclosure;

FIG. 2B is a flow chart of a method of fabricating a display device according to an embodiment of the present disclosure;

FIG. 3A is a schematic view of the structure of a display device according to another embodiment of the present disclosure;

FIG. 3B is a flow chart of a method of fabricating a display device according to an embodiment of the present disclosure;

FIG. 4 is a schematic view of a display panel according to an embodiment of the present disclosure; and

FIG. 5 is a schematic view of a backlight module according to an embodiment of the present disclosure.

### DETAILED DESCRIPTION

In order to make the technical solutions and advantages of the embodiments of the present disclosure clearer, the technical solutions of the embodiments of the present disclosure will be described clearly and completely below in detail with reference to the accompanying drawings. It is obvious that the described embodiments are part instead of all of the embodiments of the present disclosure. All other embodiments obtained by those skilled in the art, based on the described embodiments of the present disclosure, without the need for creative work, are also within the scope of the present disclosure.

When referring to the elements of the present disclosure and their embodiments, the articles “a”, “an”, “the” and “said” are intended to indicate the presence of one or more elements. The terms “including”, “comprising”, “containing” and “having” are intended to be inclusive and indicate that there may be additional elements other than the listed elements.

For the purposes described below, as denoted in the directions in the drawing, the terms “up”, “down”, “left”, “right”, “vertical”, “horizontal”, “top”, “bottom” and their derivative words should relate to the present disclosure. The term “overriding”, “on top of”, “positioned on” or “positioned on top of” means that a first element such as a first structure exists on a second element such as a second structure, wherein an intermediate element such as an interface structure may exist between the first element and the second element. The term “contacting” means connecting a first element such as a first structure to a second element such as a second structure, with or without other elements at the interface of the two elements.

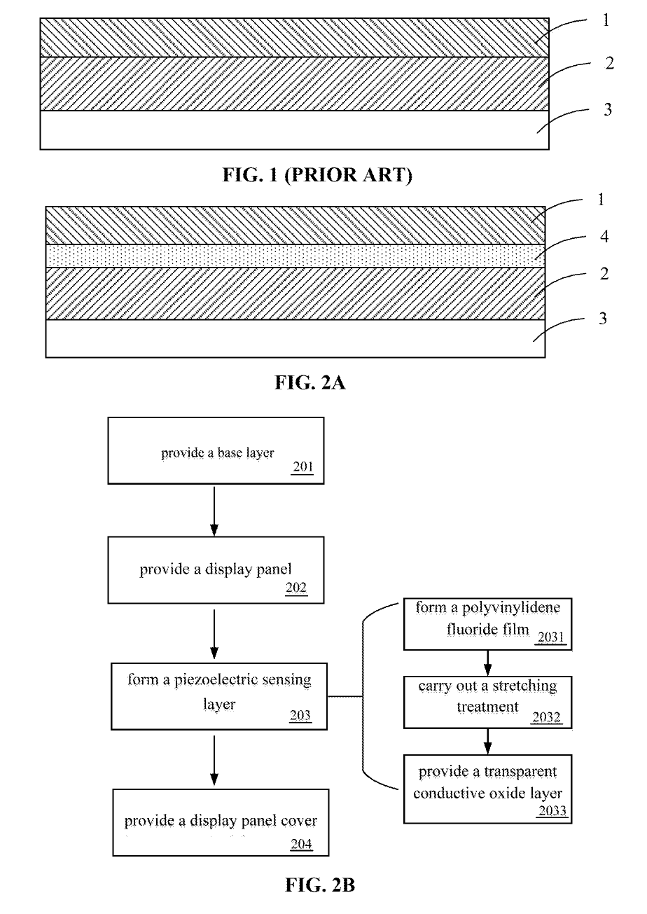

As shown in FIG. 1, in the prior art, the display device includes a base layer 3, a display panel 2 on the base layer 3, and a display panel cover 1 on the display panel 2. For the pressure sensing function, additional separate components are required to complete the pressure sensing.

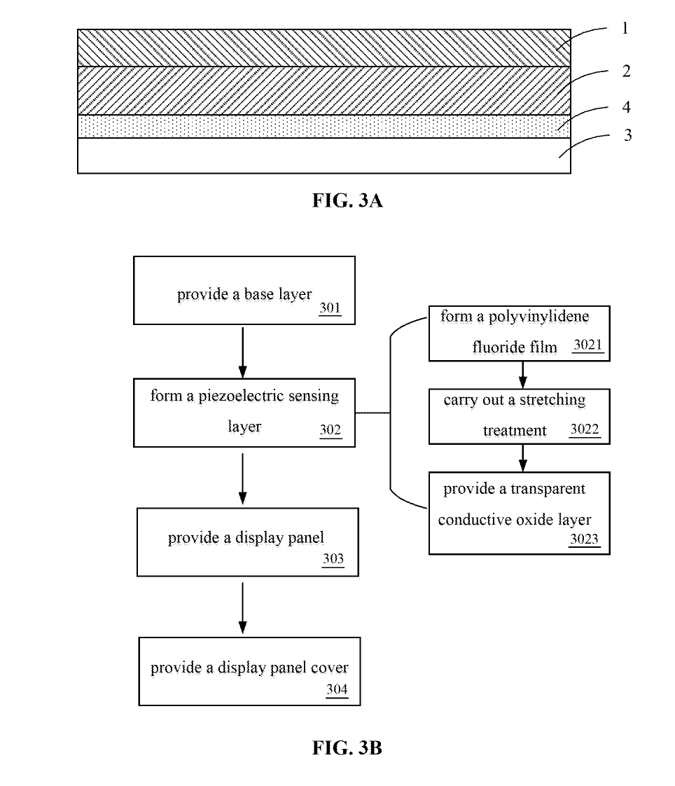

The display device provided in the embodiment of the present disclosure includes a base layer, a display panel located on the base layer, a display panel cover located on the display panel, and a piezoelectric sensing layer provided between the display panel cover and the base layer. They will be described below in detail with reference to FIGS. 2A, 2B, 3A, and 3B.

FIG. 2A is a schematic view of the structure of a display device according to an embodiment of the present disclosure. In the structure of FIG. 2A, a piezoelectric sensing layer is provided between a display panel cover and a display panel. As shown in FIG. 2A, a display panel 2 is provided on a base layer 3, a piezoelectric sensing layer 4 is provided on the display panel 2, and a display panel cover 1 is provided on the piezoelectric sensing layer. By providing the piezoelectric sensing layer between the display panel cover and the base layer, the display panel is integrated with the pressure sensing function, and is suitable to make mobile products thinner and lighter, with simple processes and high yields.

Alternatively, the display panel may be an LCD panel or an OLED panel. When the display panel is an LCD panel, the base layer includes an LCD backlight module. When the display panel is an OLED panel, the base layer includes a base substrate. It is to be noted that this solution is of course applicable to the case where the panel is an AMOLED display panel, at which point the base layer likewise includes a base substrate.

The piezoelectric sensing layer may include a polymeric piezoelectric material. For example, polyvinylidene fluoride (PVDF) can be used for the piezoelectric layer. Because of the high transparency of the polymer piezoelectric film, it does not affect the normal display of the existing panel. In addition, the polymer piezoelectric material has good processing characteristics.

FIG. 2B is a flow chart of a method of fabricating a display device according to an embodiment of the present disclosure. As shown in FIG. 2B, the method includes the following steps.

Step 201: provide a base layer.

Step 202: provide a display panel.

Step 203: form a piezoelectric sensing layer. Wherein, step 203 of forming the piezoelectric sensing layer may further include step 2031 of forming a polyvinylidene fluoride film, step 2032 of carrying out a stretching treatment, and step 2033 of providing a transparent conductive oxide layer.

Step 204: provide a display panel cover.

Alternatively, in one embodiment, the method of forming the piezoelectric sensing layer includes forming a polyvinylidene fluoride film at a temperature of from about 210° C. to 250° C. The polyvinylidene difluoride film is subjected to a stretching treatment at a temperature of from about 60° C. to 85° C. in a polarized electric field of about 40 to 60 MV/m, so that the length of the polyvinylidene fluoride film is about 3.5 to 5.5 times the length prior to the treatment, and the polyvinylidene fluoride film has a thickness in the range of from about 40 μm to 300 μm. A transparent conductive oxide layer is provided on each of the upper and lower surfaces of the polyvinylidene fluoride film under a degree of vacuum of about 3.5×10^{-3Ps}, wherein the thickness of the transparent conductive oxide layer is in the range of from about 40 nm to 200 nm. The above settings not only can achieve good transparency, but also can get a good piezoelectric sensing performance.

The transparent conductive oxide may be ITO. It is also possible to draw two electrodes from the two surfaces of the polyvinylidene fluoride film, respectively.

It is to be noted that the parameters and numerical values herein are part of the embodiments among the numerous embodiments. The present disclosure also includes any other suitable treatment conditions and treatment parameters, as well as other embodiments.

A pressure-sensitive adhesive (for example, a pressure-sensitive glue) is provided on at least one surface of the polyvinylidene fluoride film. Then the polyvinylidene fluoride film is joint with the display panel via the pressure-sensitive adhesive. In order to form the structure shown in FIGS. 2A and 2B, the polyvinylidene fluoride may be bonded to the upper surface of the display panel by a bonding process, and the electrode of the polyvinylidene fluoride film may be connected to a signal receiving device. Then, on the side of the display panel where the polyvinylidene fluoride film is provided, the display panel is joint with the display panel cover so that the polyvinylidene fluoride film is located between the display panel and the display panel cover.

FIG. 3A is a schematic view of the structure of a display device according to an embodiment of the present disclosure. Different from the structure in FIG. 2A, the piezoelectric sensing layer is located between the display panel and the base layer in FIG. 3A. As shown in FIG. 3A, a piezoelectric sensing layer 4 is provided on the base layer 3, a display panel 2 is provided on the piezoelectric sensing layer 4, and a display panel cover 1 is provided on the display panel 2.

Alternatively, the display panel may be a liquid crystal (LCD) panel or an organic light emitting diode (OLED) panel. When the display panel is an LCD panel, the base layer includes an LCD backlight module. When the display panel is an OLED panel, the base layer includes a base substrate. It is to be noted that this solution is of course applicable to the case where the panel is an active matrix organic light emitting diode (AMOLED) display panel, at which point the base layer likewise includes a base substrate.

The piezoelectric sensing layer may include a polymeric piezoelectric material. For example, polyvinylidene fluoride (PVDF) can be used for the piezoelectric layer. Because of the good transparency of the polymer piezoelectric film, it does not affect the normal display of the existing panel. Moreover, the polymer piezoelectric material has good processing characteristics.

FIG. 3B is a flow chart of a method of fabricating a display device according to an embodiment of the present disclosure. As shown in FIG. 3B, the method includes the following steps.

Step 301: provide a base layer.

Step 302: form a piezoelectric sensing layer. Wherein, step 302 of forming the piezoelectric sensing layer may further include step 3021 of forming a polyvinylidene fluoride film, step 3022 of carrying out a stretching treatment, and step 3023 of providing a transparent conductive oxide layer.

Step 303: provide a display panel.

Step 304: provide a display panel cover.

By providing the piezoelectric sensing layer between the display panel cover and the base layer, the display panel is integrated with the pressure sensing function, and is suitable to make mobile products thinner and lighter, with simple processes and high yields.

Alternatively, in one embodiment, the method of forming the piezoelectric sensing layer includes forming a polyvinylidene fluoride film at a temperature of from about 210° C. to 250° C. The polyvinylidene difluoride film is subjected to a stretching treatment at a temperature of from about 60° C. to 85° C. in a polarized electric field of about 40 to 60 MV/m, so that the length of the polyvinylidene fluoride film is about 3.5 to 5.5 times of the length prior to the treatment, and the polyvinylidene fluoride film has a thickness in the range of from about 40 μm to 300 μm. A transparent conductive oxide layer is provided on each of the upper and lower surfaces of the polyvinylidene fluoride film under a degree of vacuum of about 3.5×10^{-3Ps}, wherein the thickness of the transparent conductive oxide layer is in the range of from about 40 nm to 200 nm. The above settings not only can achieve good transparency, but also can get a good piezoelectric sensing performance.

The transparent conductive oxide may be ITO. It is also possible to draw two electrodes from the two surfaces of the polyvinylidene fluoride film, respectively.

It is to be noted that the parameters and numerical values herein are part of the embodiments among the numerous embodiments. The present disclosure also includes any other suitable treatment conditions and treatment parameters, as well as other embodiments.

A pressure-sensitive adhesive (for example, a pressure-sensitive glue) is provided on at least one surface of the polyvinylidene fluoride film. Then the polyvinylidene fluoride film is joint with the base layer via the pressure-sensitive adhesive. In order to form the structure shown in FIGS. 3A and 3B, the polyvinylidene fluoride may be bonded to the lower surface of the display panel by a bonding process, and the electrode of the polyvinylidene fluoride film may be connected to a signal receiving device. Then, on the side of the display panel where the polyvinylidene fluoride film is provided, the display panel is joint with the base layer, so that the polyvinylidene fluoride film is located between the display panel and the base layer.

The display device may be a device having a display function such as a display panel, a display, a television set, a tablet computer, a mobile phone, a navigator, etc., and the present disclosure is not limited thereto.

One embodiment of the present disclosure provides a display panel in which a piezoelectric sensing layer is provided on the display side or the side opposite to the display side of the display panel.

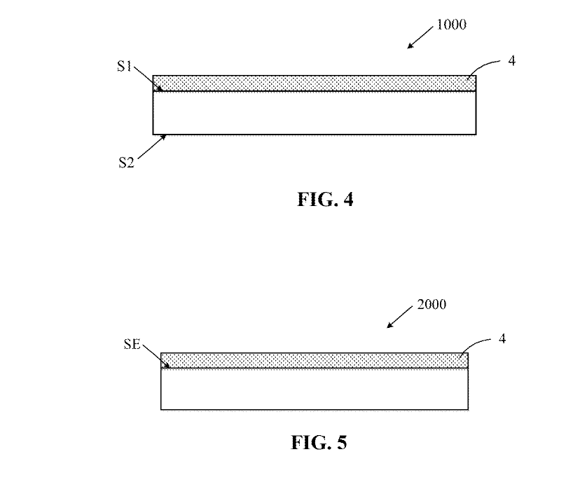

FIG. 4 is a schematic view of a display panel according to an embodiment of the present disclosure. As shown in FIG. 4, a piezoelectric sensing layer 4 is provided on a display side 51 or the side S2 opposite to the display side 51 of the display panel 1000.

A further embodiment of the present disclosure provides a backlight module in which a piezoelectric sensing layer is provided on the light exit side of the backlight module. The backlight module according to an embodiment of the present disclosure is able to be integrated with the pressure sensing function, and is suitable to make mobile products thinner and lighter, with simple processes and high yields.

FIG. 5 is a schematic view of a backlight module according to an embodiment of the present disclosure. As shown in FIG. 5, a piezoelectric sensing layer 4 is provided on a light exit side SE of the backlight module 2000.

According to the technical solutions of the present disclosure, a display panel having a pressure sensing function can be obtained. By providing the piezoelectric sensing layer between the display panel cover and the base layer, the display panel is integrated with the pressure sensing function, and is suitable to make mobile products thinner and lighter, with simple processes and high yields.

Certain particular embodiments have been described, but these embodiments are presented by way of example only and are not intended to limit the scope of the present disclosure. In fact, the novel embodiments described herein may be embodied in various other forms, in addition, various omissions, substitutions and alterations in the form of the embodiments described herein may be made without departing from the spirit of the present disclosure. The appended claims and their equivalents are intended to cover such forms or modifications falling within the scope and spirit of the present disclosure.

1. A display device comprising:
a base layer;
a display panel located on the base layer; and
a display panel cover located on the display panel, wherein the display device further comprises a piezoelectric sensing layer provided between the display panel cover and the base layer.

2. The display device according to claim 1, wherein the piezoelectric sensing layer comprises a polymeric piezoelectric material.

3. The display device according to claim 2, wherein the polymeric piezoelectric material comprises polyvinylidene fluoride.

4. The display device according to claim 1, wherein the piezoelectric sensing layer is located between the display panel cover and the display panel.

5. The display device according to claim 1, wherein the piezoelectric sensing layer is located between the display panel and the base layer.

6. The display device according to claim 1, wherein the display panel is a liquid crystal display panel, and wherein the base layer comprises a backlight module.

7. The display device according to claim 1, wherein the display panel is an organic light emitting diode display panel, and wherein the base layer comprises a base substrate.

8. The display device according to claim 1, wherein the organic light emitting diode display panel is an active matrix organic light emitting diode display panel.

9. A display panel, wherein a piezoelectric sensing layer is provided on at least one of a display side and a side opposite to the display side of the display panel.

10. A backlight module, wherein a piezoelectric sensing layer is provided on a light exit side of the backlight module.

11. A method of fabricating a display device according to claim 1, comprising:
providing the base layer;
providing the display panel on the base layer; and
providing the display panel cover on the display panel, wherein the method further comprises providing the piezoelectric sensing layer between the display panel cover and the base layer.

12. The method of fabricating a display device according to claim 11, wherein the piezoelectric sensing layer is located between the display panel cover and the display panel.

13. The method of fabricating a display device according to claim 11, wherein the piezoelectric sensing layer is located between the display panel and the base layer.

14. The method of fabricating a display device according to claim 12, wherein providing the piezoelectric sensing layer comprises:
forming a polyvinylidene fluoride film;
carrying out a stretching treatment on the polyvinylidene fluoride film so that the polyvinylidene fluoride film has a selected length and a selected thickness; and
providing a transparent conductive oxide layer on each of upper and lower surfaces of the polyvinylidene fluoride film.

15. The method of fabricating a display device according to claim 14, wherein the selected length of the polyvinylidene fluoride film is about 3.5 to 5.5 times the length prior to the treatment and the selected thickness of the polyvinylidene fluoride film is in the range of from about 40 μm to 300 μm.

16. The method of fabricating a display device according to claim 14, wherein the formation of the polyvinylidene fluoride film is carried out at a temperature of from about 210° C. to 250° C., and wherein the stretching treatment is carried out at a temperature of from about 60° C. to 85° C. in a polarized electric field of from about 40 to 60 MV/m.

17. The method of fabricating a display device according to claim 14, wherein the transparent conductive oxide layer comprises ITO, and wherein the method further comprises:
providing a pressure-sensitive adhesive on at least one surface of the polyvinylidene fluoride film; and
joining the polyvinylidene fluoride film with one of the display panel and the base layer via the pressure-sensitive adhesive.

18. The method of fabricating a display device according to claim 13, wherein providing the piezoelectric sensing layer comprises:
forming a polyvinylidene fluoride film;
carrying out a stretching treatment on the polyvinylidene fluoride film so that the polyvinylidene fluoride film has a selected length and a selected thickness; and
providing a transparent conductive oxide layer on each of upper and lower surfaces of the polyvinylidene fluoride film.

19. The display device according to claim 2, wherein the display panel is a liquid crystal display panel, and wherein the base layer comprises a backlight module.

20. The display device according to claim 2, wherein the display panel is an organic light emitting diode display panel, and wherein the base layer comprises a base substrate.
